(19) United States
(12) Patent Application Publication
(10) Pub. No.: US 2023/0109103 A1
(43) Pub. Date: Apr. 6, 2023

(54) ABNORMALITY DETECTION DEVICE AND ABNORMALITY DETECTION METHOD

(71) Applicant: Mitsubishi Electric Corporation, Tokyo (JP)

(72) Inventor: Takaaki NAKAMURA, Tokyo (JP)

(73) Assignee: Mitsubishi Electric Corporation, Tokyo (JP)

(21) Appl. No.: 18/079,451

(22) Filed: Dec. 12, 2022

Related U.S. Application Data
(63) Continuation of application No. PCT/JP2020/029684, filed on Aug. 3, 2020.

(51) Int. Cl. G06F 16/2458

(52) U.S. Cl. CPC G06F 16/2474

(57) ABSTRACT

Abnormality detection device includes: processing circuitry performing a process that: extracts a first feature amount using a sliding window of a first time length and a second feature amount using a sliding window of a second time length longer than the first time length; calculates a unit incremental value by dividing a specific value difference subtracting a first specific value in the first feature amount from a second specific value in the second feature amount by a time length difference subtracting the first time length from the second time length; sequentially calculates, for each abnormality detection time length different from each other, a threshold based on the unit incremental value; and sequentially generates, for each abnormality detection time length, a plurality of partial time series having the abnormality detection time lengths from the time series data, and detects an abnormality in the time series data based on those and the threshold.

### CROSS REFERENCE TO RELATED APPLICATIONS

This application is a Continuation of PCT International Application No. PCT/JP2020/029684 filed on Aug. 3, 2020, which is hereby expressly incorporated by reference into the present application.

### TECHNICAL FIELD

The present disclosure relates to an abnormality detection device and an abnormality detection method.

### BACKGROUND ART

As a method for detecting an abnormality in time series data, a method called Discord Discovery is known. In Discord Discovery, for example, a feature amount is extracted from time series data using a sliding window, a Euclidean distance between a part of the extracted feature amount and another part of the feature amount is calculated, and it is repeatedly determined whether or not the calculated Euclidean distance is larger than a threshold prepared in advance, thereby detecting an abnormality.

In the abnormality detection by Discord Discovery, in a case where an abnormality in time series data to be detected is known, it is possible to determine and prepare in advance an appropriate time length of a sliding window for detecting the abnormality (hereinafter, simply referred to as a “time length”) and an appropriate threshold. However, in a case where an unknown abnormality is detected, it is difficult to determine an appropriate time length and threshold.

Regarding the time length, for example, a method is conceivable in which an abnormality is detected while the time length is changed by applying the abnormality detection method disclosed in Non-Patent Literature 1.

### CITATION LIST

### Non-Patent Literature

Non-Patent Literature 1: “Dragomir Yankov, Eamonn Keogh, and Umaa Rebbapragada”, “Disk Aware Discord Discovery: Finding Unusual Time Series in Terabyte Sized Datasets”, [online], “Knowledge and Information Systems (2008, 17.2: p. 241-262)”, [searched on May 19, 2020], Internet (URL:https://www.google.co.jp/url?sa=t&rct=j&q=&esrc=s&source=web&cd=1&ved=2ahUKEwiBnqO3wr_pAhVYQd4KHVOlB-8QFjAAegQIBhAB&url=http%3A%2F%2Fwww.cs.ucr.edu %2F˜dyankov%2Fpublications%2FICDM07_DiskawareDiscords.pdf&usg=AOvVaw3Zc_r5lhPausgY6IAAXNrH)

### SUMMARY OF INVENTION

### Technical Problem

In the abnormality detection method in time series data to which the abnormality detection method disclosed in Non Patent Literature 1 is applied (hereinafter, referred to as a “conventional abnormality detection method”), it is not necessary to determine an appropriate time length in advance in order to detect an abnormality in time series data, but there is still a problem that an appropriate threshold corresponding to the time series data needs to be prepared in advance.

The present disclosure is intended to solve the above-described problems, and an object thereof is to provide an abnormality detection device capable of detecting an abnormality in time series data without preparing an appropriate time length and an appropriate threshold in advance.

### Solution to Problem

The abnormality detection device according to the present disclosure includes: processing circuitry performing a process to: acquire time series data; extract a feature amount of the time series data acquired by sliding a sliding window, the process extracting a first feature amount using the sliding window of a first time length and extracting a second feature amount using the sliding window of a second time length longer than the first time length; calculate a unit incremental value that is an increment of a specific value of a feature amount per unit time length by dividing a specific value difference by a time length difference, the specific value difference being obtained by subtracting a first specific value that is a specific value in the first feature amount from a second specific value that is a specific value in the second feature amount, and the time length difference being obtained by subtracting the first time length from the second time length; sequentially calculate, for each of a plurality of abnormality detection time lengths different from each other, a threshold for determining whether or not there is an abnormality in the time series data acquired on a basis of the unit incremental value calculated; and sequentially generate, for each of the plurality of abnormality detection time lengths different from each other, a plurality of partial time series having the abnormality detection time lengths from the time series data acquired by sliding the sliding windows of the abnormality detection time lengths, and detect an abnormality in the time series data on a basis of the plurality of generated partial time series and the threshold calculated.

### Advantageous Effects of Invention

According to the present disclosure, it is possible to detect an abnormality in time series data without preparing an appropriate time length and threshold in advance.

### BRIEF DESCRIPTION OF DRAWINGS

FIG. 1 is a block diagram illustrating an example of a configuration of a main part of an abnormality detection device according to a first embodiment and an abnormality detection system 1 to which the abnormality detection device is applied.

FIG. 2 is an explanatory diagram illustrating an example of an image indicated by image information that is abnormality information output by an abnormality output unit included in the abnormality detection device according to the first embodiment.

FIG. 3 is an explanatory diagram illustrating another example of an image indicated by image information that is abnormality information output by the abnormality output unit included in the abnormality detection device according to the first embodiment.

FIG. 4 is an explanatory diagram illustrating another example of an image indicated by image information that is abnormality information output by the abnormality output unit included in the abnormality detection device according to the first embodiment.

FIGS. 5A and 5B are diagrams illustrating an example of a hardware configuration of a main part of the abnormality detection device according to the first embodiment.

FIG. 6 is a flowchart for explaining an example of processing of the abnormality detection device according to the first embodiment.

### DESCRIPTION OF EMBODIMENTS

Hereinafter, an embodiment of the present disclosure will be described in detail with reference to the drawings.

### First Embodiment

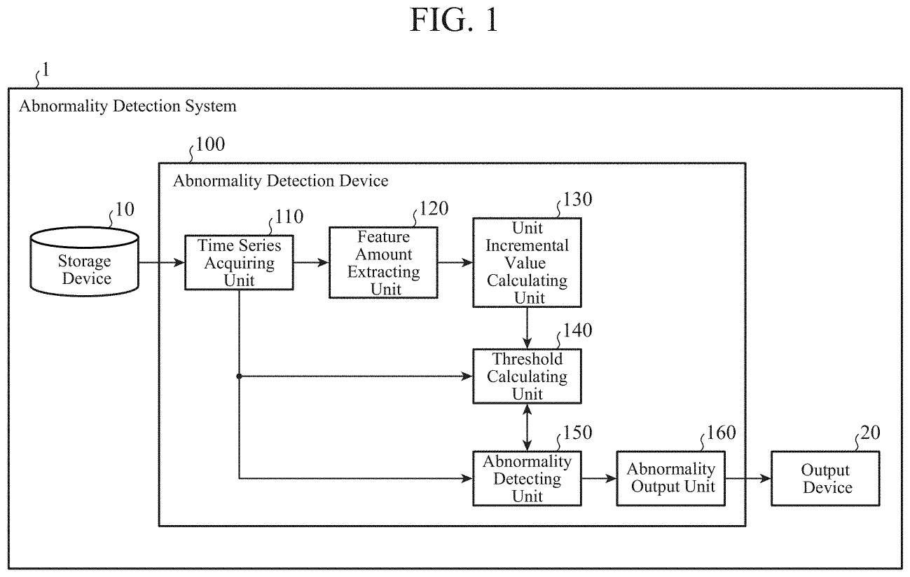

An abnormality detection device 100 according to a first embodiment will be described with reference to FIGS. 1 to 6.

With reference to FIG. 1, a configuration of a main part of the abnormality detection device 100 according to the first embodiment and an abnormality detection system 1 to which the abnormality detection device 100 is applied.

FIG. 1 is a block diagram illustrating an example of a configuration of a main part of the abnormality detection device 100 according to the first embodiment and the abnormality detection system 1 to which the abnormality detection device 100 is applied.

The abnormality detection system 1 according to the first embodiment includes the abnormality detection device 100, a storage device 10, and an output device 20.

The abnormality detection device 100 acquires time series data and detects an abnormality in the acquired time series data. The abnormality detection device 100 outputs abnormality information indicating the abnormality detected by the abnormality detection device 100. Details of the abnormality detection device 100 will be described later.

The storage device 10 stores information necessary for the abnormality detection device 100 to detect an abnormality in the time series data.

Specifically, for example, the storage device 10 stores in advance the time series data acquired by the abnormality detection device 100. The abnormality detection device 100 acquires the time series data by reading the time series data stored in advance in the storage device 10 from the storage device 10.

The storage device 10 may acquire the abnormality information output by the abnormality detection device 100 from the abnormality detection device 100 and store the acquired abnormality information. In this case, the abnormality detection device 100 outputs the abnormality information to the storage device 10 and causes the storage device 10 to store the abnormality information.

Examples of the output device 20 include a display output device such as a display and a voice output device such as a speaker.

The output device 20 acquires the abnormality information output by the abnormality detection device 100, and outputs an abnormality indicated by the acquired abnormality information in a state in which a user can recognize the abnormality. That is, the abnormality detection device 100 outputs the abnormality information to the output device 20, and causes the output device 20 to perform display output, voice output, or the like of the output abnormality information.

The abnormality detection device 100 will be described.

The abnormality detection device 100 according to the first embodiment includes a time series acquiring unit 110, a feature amount extracting unit 120, a unit incremental value calculating unit 130, a threshold calculating unit 140, an abnormality detecting unit 150, and an abnormality output unit 160.

The time series acquiring unit 110 acquires time series data.

Specifically, for example, by reading time series data stored in advance in the storage device 10 from the storage device 10, the time series acquiring unit 110 acquires the time series data.

The time series data is obtained by converting a signal output from a sensor such as a vibration sensor, a distance measuring sensor, a rotation sensor, a gyro sensor, a temperature sensor, or a sound sensor into time series information. The time series data is not limited to data obtained by converting a signal output from a sensor into time series information as long as the time series data is time series information indicating a physical quantity measured, observed, or aggregated at predetermined time intervals. Note that the predetermined time interval does not need to be a uniform interval, and the time interval includes any interval.

The time series acquiring unit 110 only needs to be able to acquire the time series data, and an acquisition source of the time series data acquired by the time series acquiring unit 110 or a method for acquiring the time series data by the time series acquiring unit 110 is not limited.

The feature amount extracting unit 120 extracts a feature amount of the time series data acquired by the time series acquiring unit 110 by sliding a sliding window.

For example, every time the sliding window is slid, the feature amount extracting unit 120 extracts a feature value in the sliding window in the time series data. The feature value in the sliding window is a maximum value in the sliding window, a value obtained by subtracting a minimum value from the maximum value, an average value, a root mean square value, a variance, a standard deviation, or the like. The feature value in the sliding window may be a matrix profile value disclosed in Literature 1 below.

Literature 1: “Yeh, Chin-Chia Michael, et al.”, “Matrix profile I: all pairs similarity joins for time series: a unifying view that includes motifs, discords and shapelets.”, [online], “2016 IEEE 16th international conference on data mining (ICDM). Ieee, (2016)”, URL:https://www.cs.ucr.edu/˜eamonn/PID4481997_extend Matrix%20Profile_I.pdf

The feature amount extracted by the feature amount extracting unit 120 is time series information of a feature value including a feature value in each sliding window in the time series data.

Specifically, the feature amount extracting unit 120 extracts a first feature amount using a sliding window of a first time length. In addition, the feature amount extracting unit 120 extracts a second feature amount using a sliding window of a second time length longer than the first time length.

Hereinafter, description will be given in such a manner that a value of the first time length is denoted by L, a value of the second time length is denoted by L+a, the first feature amount is denoted by MP_{L}, and the second feature amount is denoted by MP_{L+a}.

Here, L that is the first time length is any value equal to or more than a minimum value of a predetermined time interval at which a physical quantity is measured, observed, or aggregated, and during which L+a that is the second time length is equal to or less than a time length corresponding to a period from a start point to an end point of the time series data (this is, referred to as a “time series data length”) in the time series data acquired by the time series acquiring unit 110. Note that, in a case where L that is the first time length is a short value close to the minimum value of the time interval, the first feature amount includes high-frequency noise in the time series data. In a case where L that is the first time length is a long value close to the time length corresponding to the time series data length, the first feature amount does not include a high-frequency component in the time series data. Therefore, for example, L that is the first time length is preferably a value several times, specifically, about 5 times to 10 times the minimum value of the time interval.

In addition, a that is a difference between the second time length and the first time length (hereinafter, referred to as a “time length difference”) is any value equal to or more than a minimum value of a predetermined time interval at which a physical quantity is measured, observed, or aggregated, and that L+a which is the second time length is equal to or less than a time length corresponding to the time series data length in the time series data acquired by the time series acquiring unit 110. Note that, in a case where a that is the time length difference is a short value close to the minimum value of the time interval, the first feature amount and the second feature amount are similar to each other. In a case where a that is the time length difference is a long value close to the time length corresponding to the time series data length, the second feature amount does not include a high-frequency component in the time series data. Therefore, for example, a that is the time length difference is preferably a value that is a fraction of the time series data length, specifically, about 1/10 to ⅕ of the time series data length.

Specifically, for example, a is calculated by the following formula (1).

a=ceil{(U−L)/k} formula (1)

Here, ceil (x) is a function having a minimum integer value equal to or more than a real number x as a return value. U is a time length corresponding to the time series data length, and k is a predetermined constant such as 5 or 10, for example.

By dividing a specific value difference obtained by subtracting a first specific value that is a specific feature value (hereinafter referred to as “specific value”) in the first feature amount from a second specific value that is a specific value in the second feature amount by a time length difference obtained by subtracting the first time length from the second time length, the unit incremental value calculating unit 130 calculates a unit incremental value that is an increment of a specific value of a feature amount per unit time length.

For example, the specific value in the first feature amount is a maximum value in the first feature amount. The specific value in the first feature amount is not limited to the maximum value in the first feature amount. For example, the specific value in the first feature amount may be a second or third largest value, a median value, or a most frequent value in the first feature amount. In addition, for example, the specific value in the first feature amount may be a statistical value such as an average value or a root mean square value of some or all values in the first feature amount. The specific value in the second feature amount is also similar to the specific value in the first feature amount.

Specifically, for example, in a case where the specific value in the first feature amount is a maximum value, the specific value in the second feature amount is a maximum value, and in a case where the specific value in the first feature amount is a median value, the specific value in the second feature amount is a median value. That is, similar specific values are used as the specific value in the first feature amount and the specific value in the second feature amount.

Hereinafter, description will be given on the assumption that the specific value in the first feature amount is a maximum value in the first feature amount, and the specific value in the second feature amount is a maximum value in the second feature amount.

Specifically, for example, the unit incremental value calculating unit 130 calculates a unit incremental value by the following formula (2) using a max function.

ε=(max(MP_{L+a})−max(MP_{L}))/((L+a)−L) formula (2)

Here, ε is a unit incremental value.

For each of the plurality of abnormality detection time lengths different from each other, the threshold calculating unit 140 sequentially calculates a threshold for determining presence or absence of an abnormality in the time series data acquired by the time series acquiring unit 110 on the basis of the unit incremental value calculated by the unit incremental value calculating unit 130.

The abnormality detection time length is, for example, any time length from the first time length to a time length corresponding to the time series data length. Details of the abnormality detection time length will be described later.

The abnormality detecting unit 150 sequentially generates, for each of the plurality of abnormality detection time lengths different from each other, a plurality of partial time series having the abnormality detection time lengths from the time series data acquired by the time series acquiring unit 110 by sliding the sliding windows of the abnormality detection time lengths. The abnormality detecting unit 150 detects an abnormality in the time series data on the basis of the plurality of partial time series generated by the abnormality detecting unit 150 and the threshold calculated by the threshold calculating unit 140.

Specifically, for example, the abnormality detecting unit 150 calculates a distance between two partial time series in each of a plurality of partial time series sets obtained by combining two partial time series among the plurality of partial time series generated by the abnormality detecting unit 150. Here, the distance between the two partial time series is a measure for measuring a similarity between the two partial time series. Specifically, for example, the distance is not only a simple Euclidean distance but also a normalized Euclidean distance, a Manhattan distance, dynamic time warping (DTW), or an absolute value of a correlation coefficient.

The abnormality detecting unit 150 detects an abnormality in the time series data by comparing each of the plurality of distances calculated by the abnormality detecting unit 150 with the threshold calculated by the threshold calculating unit 140.

The abnormality detection time length will be described.

As described above, the abnormality detection time length is, for example, any time length from the first time length to the time length corresponding to the time series data length.

Specifically, for example, each of the plurality of abnormality detection time lengths different from each other is a time length in which an interval between adjacent time lengths in the interval satisfying the following formula (3) is a predetermined time length interval.

m=L+S×n(m≤U,0≤n≤N) formula (3)

Here, m is an abnormality detection time length, S is a predetermined time length interval, and n is an integer equal to or more than 0 and equal to or less than N at which m is equal to or less than U.

Note that n only needs to be an integer equal to or more than 0 and equal to or less than N at which m is equal to or less than U, and in a case where U′ is a predetermined value equal to or more than L and less than U, n may be an integer equal to or more than 0 and equal to or less than N′ at which m is equal to or less than U′.

In addition, n does not need to be all integers equal to or more than 0 satisfying formula (3). For example, n may be integers in which two adjacent integers have a non-uniform interval, such as 0, 1, 2, 5, 10, 20, and 50.

In addition, n does not need to include 0, and n may be a positive integer.

Hereinafter, description will be given on the assumption that each of the plurality of abnormality detection time lengths for which the threshold calculating unit 140 calculates the threshold and each of the plurality of abnormality detection time lengths for which the abnormality detecting unit 150 detects an abnormality in the time series data satisfy formula (3). Specifically, hereinafter, description will be given on the assumption that the threshold calculating unit 140 sequentially calculates the threshold for each of all the abnormality detection time lengths satisfying formula (3), and the abnormality detecting unit 150 sequentially detects an abnormality in the time series data for each of all the abnormality detection time lengths satisfying formula (3).

First, in a case where n=0, that is, in a case where the abnormality detection time length is L, the threshold calculating unit 140 calculates the threshold by acquiring a maximum value in the first feature amount. Specifically, in a case where the abnormality detection time length is L, the threshold calculating unit 140 calculates the threshold by the following formula (4) using a max function.

r_{L}=max(MP_{L}) formula (4)

Here, r_{L} is a threshold in a case where the abnormality detection time length is L.

The abnormality detecting unit 150 generates a plurality of partial time series each having the time length L from the time series data acquired by the time series acquiring unit 110 by sliding a sliding window of the abnormality detection time length L. The abnormality detecting unit 150 detects an abnormality in the time series data on the basis of the plurality of partial time series generated by the abnormality detecting unit 150 and the threshold r_{L}, calculated by the threshold calculating unit 140.

Specifically, the abnormality detecting unit 150 detects an abnormality in the time series data by an abnormality detection method using a candidates selection phase and a discord refinement phase disclosed in Literature 2 below.

Literature 2: “Dragomir Yankov, Eamonn Keogh, and Umaa Rebbapragada”, “Disk Aware Discord Discovery: Finding Unusual Time Series in Terabyte Sized Datasets”, [online], “Knowledge and Information Systems (2008, 17.2: p. 241-262)”, URL:https://www.google.co.jp/url?sa=t&rct=j &q=&esrc=s&source=web&cd=1&ved=2 ahUKEwiBnqO3wr_pAhVYQd4KHVOlB-8QFjAAegQIBhAB&url=http%3A%2F%2Fwww.cs.ucr.edu%2F˜dyankov%2Fpublications%2FICDM07_DiskawareDiscords.pdf&usg=AOvVaw3Zc_r5lhPausgY6IAAXNrH

In a case where the abnormality detecting unit 150 detects an abnormality in the time series data, the abnormality detecting unit 150 outputs detection information in which, for example, an abnormality detection time length at the time of detecting the abnormality, a distance at the time of detecting the abnormality, and the position of the sliding window in the time series data at the time of detecting the abnormality are associated with each other.

Thereafter, for example, when calculating a threshold corresponding to each of the plurality of abnormality detection time lengths different from each other, the threshold calculating unit 140 calculates a threshold corresponding to each of the abnormality detection time lengths on the basis of the abnormality detection time length corresponding to a threshold to be calculated in addition to the unit incremental value calculated by the unit incremental value calculating unit 130.

Specifically, for example, in a case of each of n=1 to n=N, that is, in a case where the abnormality detection time length is each of L+S to L+S×N, the threshold is sequentially calculated by the following formula (5).

r_{L+S×n}=max(MP_{L})+ε×S×n formula (5)

Here, r_{L+S×n} is a threshold in a case where the abnormality detection time length is L+S×n.

In addition, for example, when calculating a threshold corresponding to each of the plurality of abnormality detection time lengths different from each other, the threshold calculating unit 140 may calculate a threshold corresponding to each of the abnormality detection time lengths on the basis of a specific distance among distances corresponding to one or more abnormalities that have been detected by the abnormality detecting unit 150 (hereinafter, referred to as a “specific distance”) in addition to the unit incremental value calculated by the unit incremental value calculating unit 130.

Specifically, for example, when calculating a threshold corresponding to a second abnormality detection time length longer than a first abnormality detection time length, the threshold calculating unit 140 calculates a threshold corresponding to the second abnormality detection time length by adding a value obtained by multiplying a value obtained by subtracting the first abnormality detection time length from the second abnormality detection time length by the unit incremental value calculated by the unit incremental value calculating unit 130 and a specific distance among distances corresponding to one or more abnormalities detected by sliding of a sliding window of the first abnormality detection time length by the abnormality detecting unit 150.

The specific distance used when the threshold calculating unit 140 calculates a threshold corresponding to each of the plurality of abnormality detection time lengths different from each other is, for example, a maximum value among distances corresponding to one or more abnormalities detected by sliding of the sliding window of the first abnormality detection time length by the abnormality detecting unit 150.

For example, in a case of each of n=1 to n=N, that is, in a case where the abnormality detection time length is each of L+S to L+S×N, the threshold calculating unit 140 sequentially calculates the threshold by the following formula (6).

r_{L+S×n}=max(D_{L+S×(n-1).}dist)+ε×S formula (6)

Here, D_{L+S×(n-1)} is a set of abnormalities detected by the abnormality detecting unit 150 in a case where the abnormality detection time length is L+S×(n−1), and D_{L+S×(n-1).} dist is a set of distances corresponding to abnormalities detected by the abnormality detecting unit 150 in a case where the abnormality detection time length is L+S×(n−1).

The specific distance used when the threshold calculating unit 140 calculates a threshold corresponding to each of the plurality of abnormality detection time lengths different from each other is not limited to a maximum value among distances corresponding to one or more abnormalities that have been detected by the abnormality detecting unit 150. For example, the specific distance used when the threshold calculating unit 140 calculates a threshold corresponding to each of the plurality of abnormality detection time lengths different from each other may be a second or third largest value, a median value, or a most frequent value among distances corresponding to one or more abnormalities that have been detected by the abnormality detecting unit 150. In addition, for example, the specific distance used when the threshold calculating unit 140 calculates a threshold corresponding to each of the plurality of abnormality detection time lengths different from each other may be a statistical value such as an average value or a root mean square value of some or all of distances corresponding to one or more abnormalities that have been detected by the abnormality detecting unit 150.

In a case of each of n=1 to n=N, that is, in a case where the abnormality detection time length is each of L+S to L+S×N, the abnormality detecting unit 150 sequentially generates a plurality of partial time series having the time length of L+S×n from the time series data acquired by the time series acquiring unit 110 by sliding a sliding window of the abnormality detection time length of L+S×n. The abnormality detecting unit 150 detects an abnormality in the time series data on the basis of the plurality of partial time series generated by the abnormality detecting unit 150 and the threshold r_{L+S×n} calculated by the threshold calculating unit 140.

Specifically, the abnormality detecting unit 150 detects an abnormality in the time series data by the abnormality detection method using the candidates selection phase and the discord refinement phase disclosed in Literature 2 described above.

In a case where the abnormality detecting unit 150 detects an abnormality in the time series data, the abnormality detecting unit 150 outputs detection information in which, for example, an abnormality detection time length at the time of detecting the abnormality, a distance at the time of detecting the abnormality, and the position of the sliding window in the time series data at the time of detecting the abnormality are associated with each other.

The abnormality output unit 160 outputs abnormality information indicating the abnormality detected by the abnormality detecting unit 150.

Specifically, for example, the abnormality output unit 160 outputs the abnormality information to the output device 20, and causes the output device 20 to perform display output, voice output, or the like of the output abnormality information.

The abnormality output unit 160 may output the abnormality information to the storage device 10 and causes the storage device 10 to store the output abnormality information.

Hereinafter, a case where the abnormality output unit 160 outputs the abnormality information to a display output device which is the output device 20 will be described.

In a case where the abnormality output unit 160 outputs the abnormality information to the display output device, for example, the abnormality output unit 160 generates an image indicating the abnormality detected by the abnormality detecting unit 150 and outputs image information indicating the generated image to the display output device as the abnormality information.

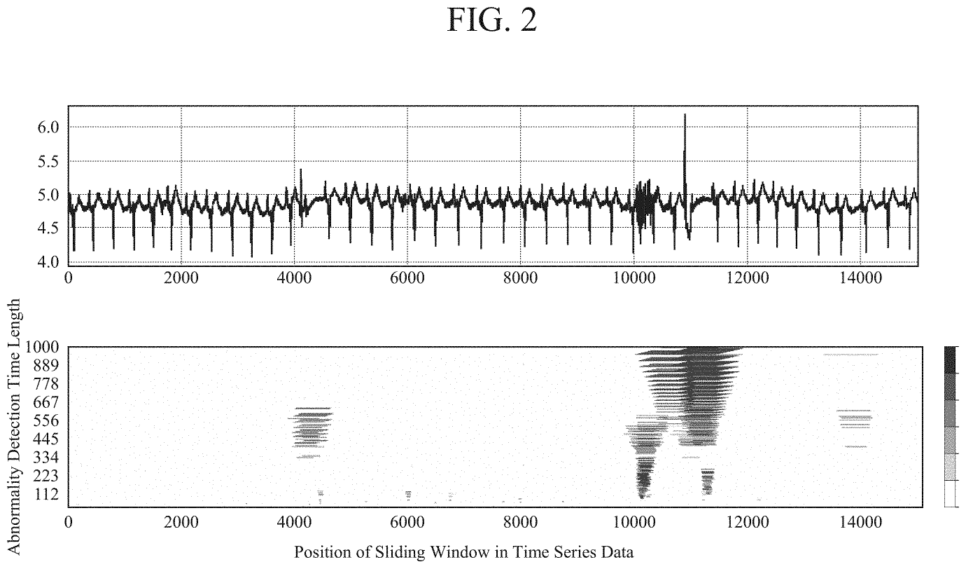

An image indicated by image information that is the abnormality information output by the abnormality output unit 160 will be described with reference to FIGS. 2 to 4.

FIG. 2 is an explanatory diagram illustrating an example of an image indicated by image information that is the abnormality information output by the abnormality output unit 160.

As illustrated in the lower part of FIG. 2, for example, the abnormality output unit 160 generates, on the basis of the detection information output by the abnormality detecting unit 150, an image in which an abnormality detection time length at the time of detecting an abnormality indicated by the detection information is associated with the position of the sliding window in the time series data at the time of detecting the abnormality indicated by the detection information.

For example, for each abnormality detection time length at the time of detecting the abnormality indicated by the detection information, the abnormality output unit 160 may generate an image in which the abnormality detection time length at the time of detecting the abnormality indicated by the detection information is associated with the position of the sliding window in the time series data at the time of detecting the abnormality indicated by the detection information for a predetermined number of pieces of detection information in descending order of a distance indicated by the detection information.

FIG. 2 illustrates, as an example, an image in which for each abnormality detection time length at the time of detecting an abnormality indicated by the detection information, the abnormality output unit 160 associates the abnormality detection time length at the time of detecting the abnormality indicated by the detection information with the position of the sliding window in the time series data at the time of detecting the abnormality indicated by the detection information for five pieces of detection information in descending order of a distance indicated by the detection information.

Specifically, FIG. 2 illustrates, as an example, an image in which an abnormality detection time length at the time of detecting an abnormality indicated by the detection information is associated with the position of the sliding window in the time series data at the time of detecting the abnormality indicated by the detection information using colors closer to black in descending order of a distance indicated by the detection information.

The abnormality output unit 160 outputs the abnormality information as illustrated in FIG. 2. As a result, a user can confirm a position where the abnormality detected by the abnormality detecting unit 150 is dense in the time series data by viewing the image displayed on the output device 20. As a result, the user can easily recognize that the abnormality in the time series data occurs at the position.

In addition to the image in which the abnormality detection time length at the time of detecting the abnormality indicated by the detection information is associated with the position of the sliding window in the time series data at the time of detecting the abnormality indicated by the detection information, the abnormality output unit 160 may generate an image indicating time series data associated with the image as illustrated in the upper part of FIG. 2.

With this configuration, the user can confirm time series data corresponding to the position where the abnormality occurs in the time series data.

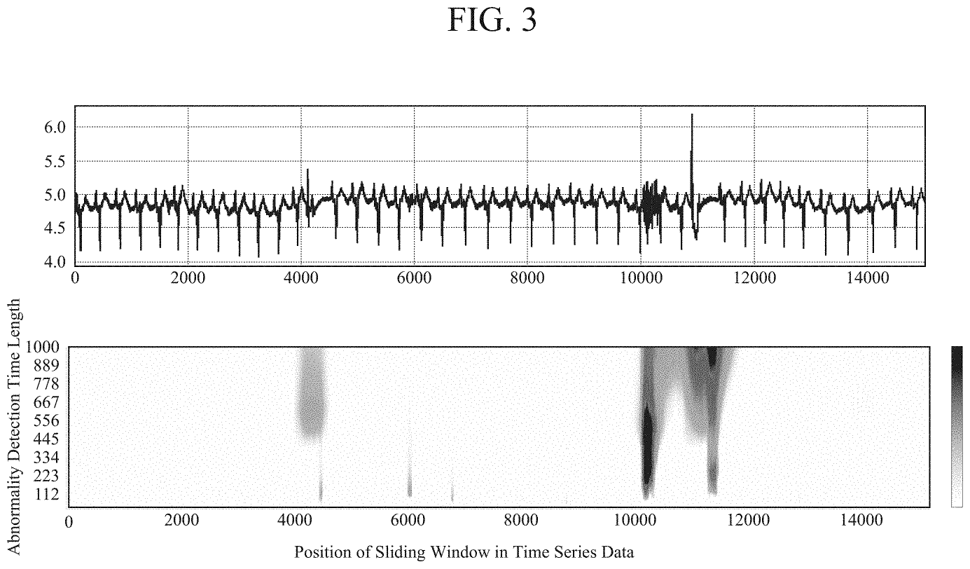

FIG. 3 is an explanatory diagram illustrating another example of an image indicated by image information that is abnormality information output by the abnormality output unit 160.

Specifically, FIG. 3 is an image in which the abnormality detection time length at the time of detecting the abnormality indicated by the detection information illustrated in FIG. 2 is associated with the position of the sliding window in the time series data at the time of detecting the abnormality indicated by the detection information as a heat map. FIG. 3 illustrates that the closer the color in the heat map is to white, the smaller the distance indicated by the detection information is, and the closer the color in the heat map is to black, the larger the distance indicated by the detection information is.

The abnormality output unit 160 outputs the abnormality information as illustrated in FIG. 3. As a result, a user can confirm a position where the abnormality detected by the abnormality detecting unit 150 is dense in the time series data by viewing the image displayed on the output device 20. As a result, the user can easily recognize that the abnormality in the time series data occurs at the position.

As illustrated in FIG. 3, in addition to the image in which the abnormality detection time length at the time of detecting the abnormality indicated by the detection information is associated with the position of the sliding window in the time series data at the time of detecting the abnormality indicated by the detection information, the abnormality output unit 160 may generate an image indicating time series data associated with the image.

With this configuration, the user can confirm time series data corresponding to the position where the abnormality occurs in the time series data.

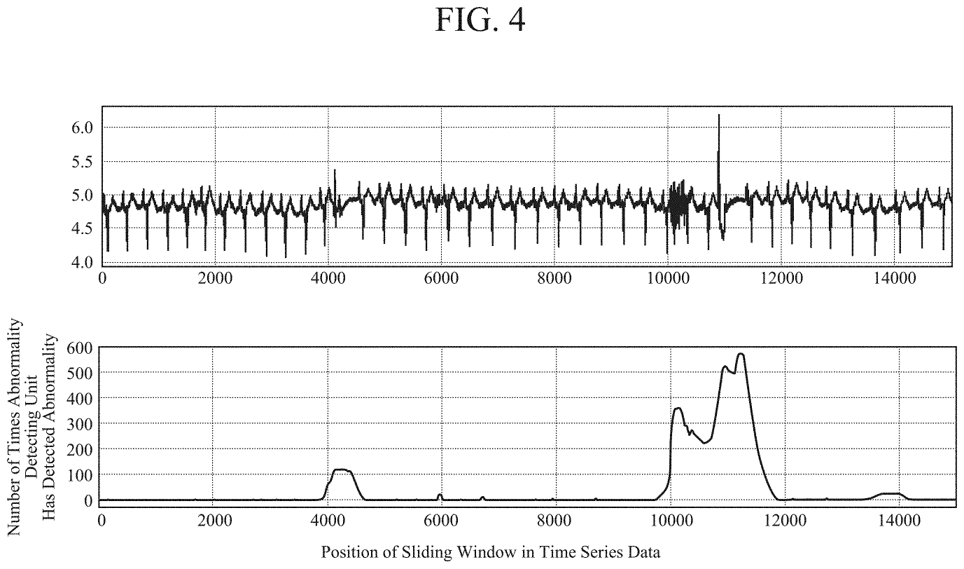

FIG. 4 is an explanatory diagram illustrating another example of an image indicated by image information that is abnormality information output by the abnormality output unit 160.

As illustrated in FIG. 4, for example, the abnormality output unit 160 generates, on the basis of the detection information output by the abnormality detecting unit 150, an image in which the position of the sliding window in the time series data at the time of detecting the abnormality indicated by the detection information is associated with the number of times the abnormality detecting unit 150 has detected the abnormality at the position.

For example, for each abnormality detection time length at the time of detecting an abnormality indicated by the detection information, the abnormality output unit 160 may generate an image in which the position of the sliding window in the time series data at the time of detecting the abnormality indicated by the detection information is associated with the number of times the abnormality detecting unit 150 has detected the abnormality at the position for a predetermined number of pieces of detection information in descending order of a distance indicated by the detection information.

FIG. 4 illustrates, as an example, am image in which for each abnormality detection time length at the time of detecting an abnormality indicated by the detection information, the abnormality output unit 160 associates the position of the sliding window in the time series data at the time of detecting the abnormality indicated by the detection information with the number of times the abnormality detecting unit 150 has detected the abnormality at the position for five pieces of detection information in descending order of a distance indicated by the detection information.

The abnormality output unit 160 outputs the abnormality information as illustrated in FIG. 4. As a result, a user can confirm a position where the abnormality detected by the abnormality detecting unit 150 often occurs in the time series data by viewing the image displayed on the output device 20. As a result, the user can easily recognize that the abnormality in the time series data occurs at the position.

As illustrated in FIG. 4, in addition to the image in which the abnormality detection time length at the time of detecting the abnormality indicated by the detection information is associated with the position of the sliding window in the time series data at the time of detecting the abnormality indicated by the detection information, the abnormality output unit 160 may generate an image indicating time series data associated with the image.

With this configuration, the user can confirm time series data corresponding to the position where the abnormality occurs in the time series data.

Note that the abnormality output unit 160 may generate an image obtained by freely combining the images illustrated in FIGS. 2 to 4.

Note that the time series data illustrated in the upper part of each of FIGS. 2 to 4 refers to “FIG. 12” disclosed in Literature 3 below and a data set of an electrocardiogram (ECG) that is a source of the “FIG. 12”.

Literature 3: “Eamonn Keogh, Jessica Lin, and Ada Fu”, “HOT SAX: Finding the Most Unusual Time Series Subsequence: Algorithms and Applications”, [online], URL:https://www.cs.ucredu/˜eamonn/discords/

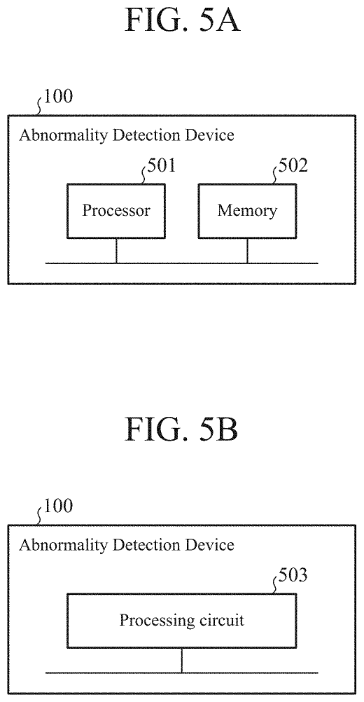

A hardware configuration of a main part of the abnormality detection device 100 according to the first embodiment will be described with reference to FIGS. 5A and 5B.

FIGS. 5A and 5B are diagrams illustrating an example of a hardware configuration of a main part of the abnormality detection device 100 according to the first embodiment.

As illustrated in FIG. 5A, the abnormality detection device 100 is constituted by a computer, and the computer includes a processor 501 and a memory 502.

The memory 502 stores a program for causing the computer to function as the time series acquiring unit 110, the feature amount extracting unit 120, the unit incremental value calculating unit 130, the threshold calculating unit 140, the abnormality detecting unit 150, and the abnormality output unit 160. The processor 501 reads and executes the program stored in the memory 502, and the time series acquiring unit 110, the feature amount extracting unit 120, the unit incremental value calculating unit 130, the threshold calculating unit 140, the abnormality detecting unit 150, and the abnormality output unit 160 are thereby implemented.

In addition, as illustrated in FIG. 5B, the abnormality detection device 100 may be constituted by a processing circuit 503. In this case, functions of the time series acquiring unit 110, the feature amount extracting unit 120, the unit incremental value calculating unit 130, the threshold calculating unit 140, the abnormality detecting unit 150, and the abnormality output unit 160 may be implemented by the processing circuit 503.

In addition, the abnormality detection device 100 may be constituted by the processor 501, the memory 502, and the processing circuit 503 (not illustrated). In this case, some of the functions of the time series acquiring unit 110, the feature amount extracting unit 120, the unit incremental value calculating unit 130, the threshold calculating unit 140, the abnormality detecting unit 150, and the abnormality output unit 160 may be implemented by the processor 501 and the memory 502, and the remaining functions may be implemented by the processing circuit 503.

The processor 501 uses, for example, a central processing unit (CPU), a graphics processing unit (GPU), a microprocessor, a microcontroller, or a digital signal processor (DSP).

The memory 502 uses, for example, a semiconductor memory or a magnetic disk. More specifically, the memory 502 uses a random access memory (RAM), a read only memory (ROM), a flash memory, an erasable programmable read only memory (EPROM), an electrically erasable programmable read-only memory (EEPROM), a solid state drive (SSD), a hard disk drive (HDD), or the like.

The processing circuit 503 uses, for example, an application specific integrated circuit (ASIC), a programmable logic device (PLD), a field-programmable gate array (FPGA), a system-on-a-chip (SoC), or a system large-scale integration (LSI).

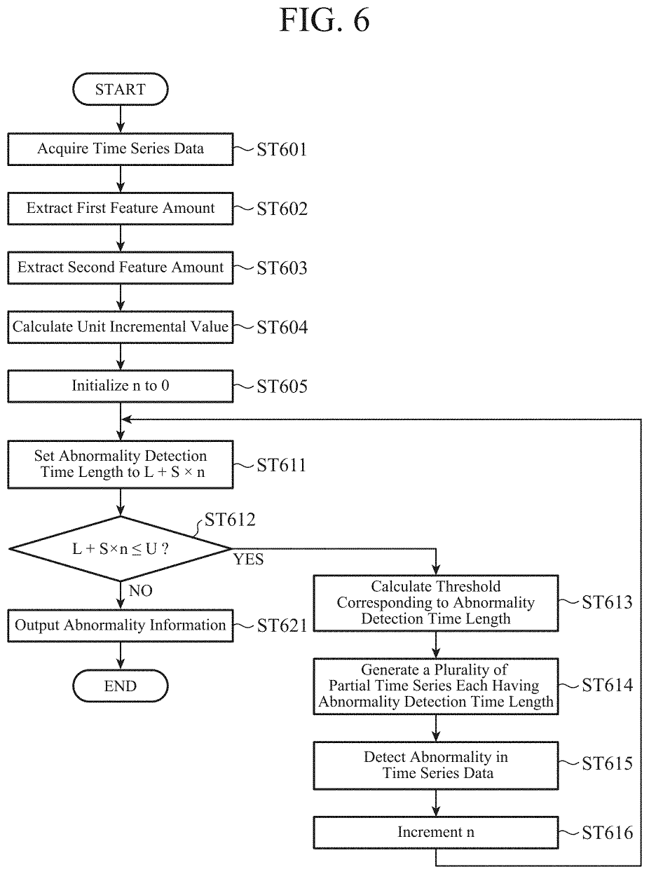

An operation of the abnormality detection device 100 according to the first embodiment will be described with reference to FIG. 6.

FIG. 6 is a flowchart for explaining an example of processing of the abnormality detection device 100 according to the first embodiment.

First, in step ST601, the time series acquiring unit 110 acquires the time series data.

Next, in step ST602, the feature amount extracting unit 120 extracts the first feature amount using the sliding window of the first time length.

Next, in step ST603, the feature amount extracting unit 120 extracts the second feature amount using the sliding window of the second time length.

Next, in step ST604, the unit incremental value calculating unit 130 calculates a unit incremental value.

Next, in step ST605, the threshold calculating unit 140 initializes n to 0.

Next, in step ST611, the threshold calculating unit 140 sets the abnormality detection time length to L+S×n.

Next, in step ST612, the threshold calculating unit 140 determines whether or not the abnormality detection time length is equal to or less than U, which is a time length corresponding to the time series data length.

In step ST612, if the threshold calculating unit 140 determines that the abnormality detection time length is equal to or less than U, which is a time length corresponding to the time series data length, in step ST613, the threshold calculating unit 140 calculates a threshold corresponding to the abnormality detection time length.

After step ST613, in step ST614, the abnormality detecting unit 150 generates a plurality of partial time series each having the abnormality detection time length from the time series data by sliding a sliding window of the abnormality detection time length.

After step ST614, in step ST615, the abnormality detecting unit 150 detects an abnormality in the time series data in a case where the abnormality detection time length is L+S×n on the basis of the plurality of partial time series generated by the abnormality detecting unit 150 and the threshold calculated by the threshold calculating unit 140.

After step ST615, in step ST616, the threshold calculating unit 140 increments n.

After step ST616, the abnormality detection device 100 returns to the process in step ST611, and in step ST612, repeatedly executes the processes from steps ST611 to ST616 until the threshold calculating unit 140 determines that the abnormality detection time length is not equal to or less than U, which is a time length corresponding to the time series data length.

In step ST612, if the threshold calculating unit 140 determines that the abnormality detection time length is not equal to or less than U, which is a time length corresponding to the time series data length, in step ST621, the abnormality output unit 160 outputs abnormality information.

After step ST621, the abnormality detection device 100 ends the processes of the flowchart.

Note that the order of the process in step ST602 and the process in step ST603 is freely determined.

As described above, the abnormality detection device 100 includes: the time series acquiring unit 110 that acquires time series data; the feature amount extracting unit 120 that extracts a feature amount of the time series data acquired by the time series acquiring unit 110 by sliding a sliding window, the feature amount extracting unit 120 extracting a first feature amount using a sliding window of a first time length and extracting a second feature amount using a sliding window of a second time length longer than the first time length; the unit incremental value calculating unit 130 that calculates a unit incremental value that is an increment of a specific value of a feature amount per unit time length by dividing a specific value difference by a time length difference, the specific value difference being obtained by subtracting a first specific value that is a specific value in the first feature amount from a second specific value that is a specific value in the second feature amount, and the time length difference being obtained by subtracting the first time length from the second time length; the threshold calculating unit 140 that sequentially calculates, for each of a plurality of abnormality detection time lengths different from each other, a threshold for determining whether or not there is an abnormality in the time series data acquired by the time series acquiring unit 110 on the basis of the unit incremental value calculated by the unit incremental value calculating unit 130; and the abnormality detecting unit 150 that sequentially generates, for each of the plurality of abnormality detection time lengths different from each other, a plurality of partial time series having the abnormality detection time lengths from the time series data acquired by the time series acquiring unit 110 by sliding the sliding windows of the abnormality detection time lengths, and detects an abnormality in the time series data on the basis of the plurality of generated partial time series and the threshold calculated by the threshold calculating unit 140.

With this configuration, the abnormality detection device 100 can detect an abnormality in the time series data without preparing an appropriate time length and threshold in advance.

In addition, the abnormality detection device 100 has a configuration in which, in the above-described configuration, the abnormality detecting unit 150 detects an abnormality in the time series data by calculating a distance between two partial time series in each of a plurality of partial time series sets obtained by combining two partial time series among the plurality of partial time series generated by the abnormality detecting unit 150 and comparing each of the plurality of calculated distances with the threshold calculated by the threshold calculating unit 140.

With this configuration, the abnormality detection device 100 can detect an abnormality in the time series data without preparing an appropriate time length and threshold in advance.

In addition, the abnormality detection device 100 has a configuration in which, in the above-described configuration, when calculating a threshold corresponding to each of the plurality of abnormality detection time lengths different from each other, the threshold calculating unit 140 calculates a threshold corresponding to each of the abnormality detection time lengths on the basis of a specific distance among distances corresponding to one or more abnormalities that have been detected by the abnormality detecting unit 150, in addition to the unit incremental value calculated by the unit incremental value calculating unit 130.

With this configuration, the abnormality detection device 100 can detect an abnormality in the time series data without preparing an appropriate time length and threshold in advance.

In addition, the abnormality detection device 100 has a configuration in which, in the above-described configuration, when calculating a threshold corresponding to the second abnormality detection time length longer than the first abnormality detection time length, the threshold calculating unit 140 calculates the threshold corresponding to the second abnormality detection time length by adding a value obtained by multiplying a value obtained by subtracting the first abnormality detection time length from the second abnormality detection time length by the unit incremental value calculated by the unit incremental value calculating unit 130 and a specific distance among distances corresponding to one or more abnormalities detected by sliding of the sliding window of the first abnormality detection time length by the abnormality detecting unit 150.

With this configuration, the abnormality detection device 100 can detect an abnormality in the time series data without preparing an appropriate time length and threshold in advance.

In addition, the abnormality detection device 100 has a configuration in which, in the above-described configuration, the specific distance used when the threshold calculating unit 140 calculates the threshold corresponding to each of the plurality of abnormality detection time lengths different from each other is a maximum value among distances corresponding to one or more abnormalities that have been detected by the abnormality detecting unit 150.

With this configuration, the abnormality detection device 100 can detect an abnormality in the time series data without preparing an appropriate time length and threshold in advance.

In addition, the abnormality detection device 100 has a configuration in which, in the above-described configuration, when calculating a threshold corresponding to each of the plurality of abnormality detection time lengths different from each other, the threshold calculating unit 140 calculates a threshold corresponding to each of the abnormality detection time lengths on the basis of the abnormality detection time length corresponding to the threshold to be calculated in addition to the unit incremental value calculated by the unit incremental value calculating unit 130.

With this configuration, the abnormality detection device 100 can detect an abnormality in the time series data without preparing an appropriate time length and threshold in advance.

In addition, the abnormality detection device 100 has a configuration in which, in the above-described configuration, the first specific value used when the unit incremental value calculating unit 130 calculates a unit incremental value is a maximum value in the first feature amount, and the second specific value is a maximum value in the second feature amount.

With this configuration, the abnormality detection device 100 can detect an abnormality in the time series data without preparing an appropriate time length and threshold in advance.

In addition, the abnormality detection device 100 has a configuration in which the abnormality detection device 100 includes, in addition to the above-described configuration, the abnormality output unit 160 that outputs abnormality information indicating an abnormality detected by the abnormality detecting unit 150, in a case where the abnormality detecting unit 150 detects an abnormality in the time series data, the abnormality detecting unit 150 outputs detection information in which an abnormality detection time length at the time of detecting the abnormality is associated with the position of the sliding window in the time series data at the time of detecting the abnormality, and in a case where the abnormality output unit 160 outputs abnormality information to a display output device, the abnormality output unit 160 generates, on the basis of the detection information output by the abnormality detecting unit 150, an image in which an abnormality detection time length at the time of detecting the abnormality indicated by the detection information is associated with the position of the sliding window in the time series data at the time of detecting the abnormality indicated by the detection information, and outputs image information indicating the generated image to the display output device as abnormality information.

With this configuration, the abnormality detection device 100 can detect an abnormality in the time series data without preparing an appropriate time length and threshold in advance.

In addition, the abnormality detection device 100 has a configuration in which the abnormality detection device 100 includes, in addition to the above-described configuration, the abnormality output unit 160 that outputs abnormality information indicating an abnormality detected by the abnormality detecting unit 150, in a case where the abnormality detecting unit 150 detects an abnormality in the time series data, the abnormality detecting unit 150 outputs detection information indicating the position of the sliding window that has detected an abnormality in the time series data, and in a case where the abnormality output unit 160 outputs abnormality information to a display output device, the abnormality output unit 160 generates, on the basis of the detection information output by the abnormality detecting unit 150, an image in which the position of the sliding window in the time series data at the time of detecting the abnormality indicated by the detection information is associated with the number of times the abnormality detecting unit 150 has detected the abnormality at the position, and outputs image information indicating the generated image to the display output device as abnormality information.

With this configuration, the abnormality detection device 100 can detect an abnormality in the time series data without preparing an appropriate time length and threshold in advance.

### Modification of First Embodiment

In the abnormality detection device 100 according to the first embodiment, the unit incremental value calculating unit 130 calculates one unit incremental value on the basis of the first feature amount and the second feature amount, the threshold calculating unit 140 calculates a threshold on the basis of the one unit incremental value, and the abnormality detecting unit 150 detects an abnormality in the time series data on the basis of the threshold.

In the abnormality detection device 100, the unit incremental value calculating unit 130 may calculate a plurality of unit incremental values. The threshold calculating unit 140 calculates a threshold on the basis of the plurality of unit incremental values calculated by the unit incremental value calculating unit 130, and the abnormality detecting unit 150 detects an abnormality in the time series data on the basis of the threshold calculated by the threshold calculating unit 140.

Specifically, for example, in addition to extracting the first feature amount using the sliding window of the first time length and extracting the second feature amount using the sliding window of the second time length longer than the first time length, the time series acquiring unit 110 extracts a third feature amount using a sliding window of a third time length longer than the second time length. Specifically, for example, the third time length is ½ of U, which is a time length corresponding to the time series data length.

By dividing a specific value difference obtained by subtracting a first specific value that is a specific value in the first feature amount from a second specific value that is a specific value in the second feature amount by a time length difference obtained by subtracting the first time length from the second time length, the unit incremental value calculating unit 130 calculates a first unit incremental value. In addition, by dividing a specific value difference obtained by subtracting a first specific value that is a specific value in the first feature amount from a third specific value that is a specific value in the third feature amount by a time length difference obtained by subtracting the first time length from the third time length, the unit incremental value calculating unit 130 calculates a second unit incremental value.

In a case where the abnormality detection time length is shorter than the third time length, for each of the plurality of abnormality detection time lengths different from each other, the threshold calculating unit 140 sequentially calculates a first threshold for determining presence or absence of an abnormality in the time series data acquired by the time series acquiring unit 110 on the basis of the first unit incremental value calculated by the unit incremental value calculating unit 130. In a case where the abnormality detection time length is equal to or longer than the third time length, for each of the plurality of abnormality detection time lengths different from each other, the threshold calculating unit 140 sequentially calculates a second threshold for determining presence or absence of an abnormality in the time series data acquired by the time series acquiring unit 110 on the basis of the second unit incremental value calculated by the unit incremental value calculating unit 130.

The abnormality detecting unit 150 sequentially generates, for each of the plurality of abnormality detection time lengths different from each other, a plurality of partial time series having the abnormality detection time lengths from the time series data acquired by the time series acquiring unit 110 by sliding the sliding windows of the abnormality detection time lengths.

The abnormality detecting unit 150 detects an abnormality in the time series data on the basis of the plurality of partial time series generated by the abnormality detecting unit 150 and the first or second threshold calculated by the threshold calculating unit 140.

Specifically, for example, in a case where the abnormality detection time length is shorter than the third time length, the abnormality detecting unit 150 detects an abnormality in the time series data on the basis of the plurality of partial time series generated by the abnormality detecting unit 150 and the first threshold calculated by the threshold calculating unit 140. In addition, in a case where the abnormality detection time length is equal to or longer than the third time length, the abnormality detecting unit 150 detects an abnormality in the time series data on the basis of the plurality of partial time series generated by the abnormality detecting unit 150 and the second threshold calculated by the threshold calculating unit 140.

Note that, in the above description, it has been described that the unit incremental value calculating unit 130 calculates two unit incremental values of the first unit incremental value and the second unit incremental value, the threshold calculating unit 140 calculates two thresholds of the first threshold and the second threshold, and the abnormality detecting unit 150 detects an abnormality in the time series data on the basis of the first threshold or the second threshold. However, the unit incremental value calculating unit 130 may calculate three or more unit incremental values, the threshold calculating unit 140 may calculate three or more thresholds, and the abnormality detecting unit 150 may detect an abnormality in the time series data on the basis of any of the three or more thresholds.

In a case where the unit incremental value calculating unit 130 calculates three or more unit incremental values, the time series acquiring unit 110 extracts a feature amount necessary for the unit incremental value calculating unit 130 to calculate three or more unit incremental values, in addition to the first feature amount, the second feature amount, and the third feature amount.

With the above configuration, the abnormality detection device 100 according to the modification of the first embodiment can detect an abnormality in the time series data with higher accuracy than the abnormality detection device 100 according to the first embodiment.

### Other Modification of First Embodiment

In the abnormality detection device 100 according to the modification of the first embodiment, the unit incremental value calculating unit 130 calculates the first unit incremental value on the basis of the first feature amount and the second time length, and calculates the second unit incremental value on the basis of the first specific value and the third time length.

The unit incremental value calculating unit 130 may calculate a plurality of unit incremental values on the basis of the first feature amount and the second time length.

Specifically, for example, the time series acquiring unit 110 extracts two values in the first feature amount using the sliding window of the first time length and extracts two values in the second feature amount using the sliding window of the second time length longer than the first time length.

More specifically, for example, the time series acquiring unit 110 extracts a first first feature amount (hereinafter, referred to as a “first first feature amount”) by sliding the sliding window of the first time length from a start point to a predetermined position in the time series data.

Here, the predetermined position in the time series data is, for example, a position corresponding to ½ of the time series data length.

In addition, the time series acquiring unit 110 extracts a second first feature amount (hereinafter, referred to as a “second first feature amount”) by sliding the sliding window of the first time length from the above-described predetermined position to an end point in the time series data.

Similarly, the time series acquiring unit 110 extracts a first second feature amount (hereinafter, referred to as a “first second feature amount”) by sliding the sliding window of the second time length from a start point to a predetermined position in the time series data. In addition, the time series acquiring unit 110 extracts a second second feature amount (hereinafter, referred to as a “second second feature amount”) by sliding the sliding window of the second time length from the above-described predetermined position to an end point in the time series data.

By dividing a specific value difference obtained by subtracting a first first specific value that is a specific value in the first first feature amount from a first second specific value that is a specific value in the first second feature amount by a time length difference obtained by subtracting the first time length from the second time length, the unit incremental value calculating unit 130 calculates a first unit incremental value.

In addition, by dividing a specific value difference obtained by subtracting a second first specific value that is a specific value in the second first feature amount from a second second specific value that is a specific value in the second second feature amount by a time length difference obtained by subtracting the first time length from the second time length, the unit incremental value calculating unit 130 calculates a second unit incremental value.

The threshold calculating unit 140 sequentially calculates a first threshold for determining presence or absence of an abnormality in the time series data acquired by the time series acquiring unit 110 on the basis of the first unit incremental value calculated by the unit incremental value calculating unit 130. Similarly, the threshold calculating unit 140 sequentially calculates a second threshold on the basis of the second unit incremental value calculated by the unit incremental value calculating unit 130.

The abnormality detecting unit 150 sequentially generates, for each of the plurality of abnormality detection time lengths different from each other, a plurality of partial time series having the abnormality detection time lengths from the time series data acquired by the time series acquiring unit 110 by sliding the sliding windows of the abnormality detection time lengths. The abnormality detecting unit 150 detects an abnormality in the time series data on the basis of the plurality of partial time series generated by the abnormality detecting unit 150 and the first or second threshold calculated by the threshold calculating unit 140.

Specifically, for example, the abnormality detecting unit 150 calculates a distance between two partial time series in each of a plurality of partial time series sets obtained by combining two partial time series among the plurality of partial time series generated by the abnormality detecting unit 150.

In a case where both of the two partial time series are partial time series included in a portion from a start point to the above-described predetermined position in the time series data, the abnormality detecting unit 150 detects an abnormality in the time series data by comparing each of the plurality of calculated distances with the first threshold calculated by the threshold calculating unit 140.

In addition, in a case where both of the two partial time series are partial time series included in a portion from the above-described predetermined position to an end point in the time series data, the abnormality detecting unit 150 detects an abnormality in the time series data by comparing each of the plurality of calculated distances with the second threshold calculated by the threshold calculating unit 140.

In addition, in a case where at least one of the two partial time series is a partial time series including the above-described predetermined position in the time series data, or in a case where one of the two partial time series is a partial time series included in a portion from a start point to the above-described predetermined position in the time series data and the other is a partial time series included in a portion from the above-described predetermined position to an end point in the time series data, the abnormality detecting unit 150 detects an abnormality in the time series data by comparing each of the plurality of calculated distances with one of the first threshold and the second threshold calculated by the threshold calculating unit 140, specifically, for example, one having a larger value out of the first threshold and the second threshold.

Note that, in the above description, it has been described that the unit incremental value calculating unit 130 calculates two unit incremental values on the basis of two values in the first feature amount and two second time lengths. However, the unit incremental value calculating unit 130 may calculate three or more unit incremental values on the basis of three or more values in the first feature amount and three or more second time lengths.

In a case where the unit incremental value calculating unit 130 calculates three or more unit incremental values, the time series acquiring unit 110 extracts a feature amount necessary for the unit incremental value calculating unit 130 to calculate unit incremental values necessary for calculating three or more thresholds, in addition to the first first feature amount, the second first feature amount, the first second feature amount, and the second second feature amount.

With the above configuration, the abnormality detection device 100 according to the other modification of the first embodiment can detect an abnormality in the time series data with higher accuracy than the abnormality detection device 100 according to the modification of the first embodiment.

Note that the present disclosure can freely combine the embodiments to each other, modify any constituent element in each of the embodiments, or omit any constituent element in each of the embodiments within the scope of the present disclosure.

### INDUSTRIAL APPLICABILITY

The abnormality detection device according to the present disclosure can be applied to an abnormality detection system.

### REFERENCE SIGNS LIST

1: abnormality detection system, 10: storage device, 20: output device, 100: abnormality detection device, 110: time series acquiring unit, 120: feature amount extracting unit, 130: unit incremental value calculating unit, 140: threshold calculating unit, 150: abnormality detecting unit, 160: abnormality output unit, 501: processor, 502: memory, 503: processing circuit

1. An abnormality detection device comprising:
processing circuitry performing a process to:
acquire time series data;
extract a feature amount of the time series data acquired by sliding a sliding window, the process extracting a first feature amount using the sliding window of a first time length and extracting a second feature amount using the sliding window of a second time length longer than the first time length;
calculate a unit incremental value that is an increment of a specific value of a feature amount per unit time length by dividing a specific value difference by a time length difference, the specific value difference being obtained by subtracting a first specific value that is a specific value in the first feature amount from a second specific value that is a specific value in the second feature amount, and the time length difference being obtained by subtracting the first time length from the second time length;
sequentially calculate, for each of a plurality of abnormality detection time lengths different from each other, a threshold for determining whether or not there is an abnormality in the time series data acquired on a basis of the unit incremental value calculated; and
sequentially generate, for each of the plurality of abnormality detection time lengths different from each other, a plurality of partial time series having the abnormality detection time lengths from the time series data acquired by sliding the sliding windows of the abnormality detection time lengths, and detect an abnormality in the time series data on a basis of the plurality of generated partial time series and the threshold calculated.

2. The abnormality detection device according to claim 1, wherein
the process detects an abnormality in the time series data by calculating a distance between two of the partial time series in each of a plurality of partial time series sets obtained by combining two of the partial time series among the plurality of partial time series generated and comparing each of the plurality of calculated distances with the threshold calculated.

3. The abnormality detection device according to claim 2, wherein
when calculating the threshold corresponding to each of the plurality of abnormality detection time lengths different from each other, the process calculates the threshold corresponding to each of the abnormality detection time lengths on a basis of a specific distance among the distances corresponding to one or more abnormalities that have been detected, in addition to the unit incremental value calculated.

4. The abnormality detection device according to claim 3, wherein
when calculating the threshold corresponding to a second abnormality detection time length longer than a first abnormality detection time length, the process calculates the threshold corresponding to the second abnormality detection time length by adding a value obtained by multiplying a value obtained by subtracting the first abnormality detection time length from the second abnormality detection time length by the unit incremental value calculated and the specific distance among the distances corresponding to one or more abnormalities detected by sliding of the sliding window of the first abnormality detection time length.

5. The abnormality detection device according to claim 3, wherein
the specific distance used when the process calculates the threshold corresponding to each of the plurality of abnormality detection time lengths different from each other is a maximum value among the distances corresponding to one or more abnormalities that have been detected.

6. The abnormality detection device according to claim 2, wherein
when calculating the threshold corresponding to each of the plurality of abnormality detection time lengths different from each other, the process calculates the threshold corresponding to each of the abnormality detection time lengths on a basis of the abnormality detection time length corresponding to the calculated threshold in addition to the unit incremental value calculated.

7. The abnormality detection device according to claim 1, wherein
the first specific value used when the process calculates the unit incremental value is a maximum value in the first feature amount, and the second specific value is a maximum value in the second feature amount.

8. The abnormality detection device according to claim 1, the process comprising to output abnormality information indicating an abnormality detected, wherein
in a case where the process detects an abnormality in the time series data, the process outputs detection information in which the abnormality detection time length at the time of detecting the abnormality is associated with a position of the sliding window in the time series data at the time of detecting the abnormality, and
in a case where the process outputs the abnormality information to a display output device, the process generates, on a basis of the detection information output, an image in which the abnormality detection time length at the time of detecting the abnormality indicated by the detection information is associated with the position of the sliding window in the time series data at the time of detecting the abnormality indicated by the detection information, and outputs image information indicating the generated image to the display output device as the abnormality information.

9. The abnormality detection device according to claim 1, the process comprising to output abnormality information indicating an abnormality detected, wherein
in a case where the process detects an abnormality in the time series data, the process outputs detection information indicating a position of the sliding window that has detected an abnormality in the time series data, and
in a case where the process outputs the abnormality information to a display output device, the process generates, on a basis of the detection information output, an image in which the position of the sliding window in the time series data at the time of detecting the abnormality indicated by the detection information is associated with the number of times the process has detected the abnormality at the position, and outputs image information indicating the generated image to the display output device as the abnormality information.

10. An abnormality detection method comprising:
acquiring time series data;
extracting a feature amount of the time series data acquired by sliding a sliding window, the method extracting a first feature amount using the sliding window of a first time length and extracting a second feature amount using the sliding window of a second time length longer than the first time length;
calculating a unit incremental value that is an increment of a specific value of a feature amount per unit time length by dividing a specific value difference by a time length difference, the specific value difference being obtained by subtracting a first specific value that is a specific value in the first feature amount from a second specific value that is a specific value in the second feature amount, and the time length difference being obtained by subtracting the first time length from the second time length;
sequentially calculating, for each of a plurality of abnormality detection time lengths different from each other, a threshold for determining whether or not there is an abnormality in the time series data acquired on a basis of the unit incremental value calculated; and
sequentially generating, for each of the plurality of abnormality detection time lengths different from each other, a plurality of partial time series having the abnormality detection time lengths from the time series data acquired by sliding the sliding windows of the abnormality detection time lengths, and detects an abnormality in the time series data on a basis of the plurality of generated partial time series and the threshold calculated.
